(19) United States
(12) Patent Application Publication
(10) Pub. No.: US 2025/0292135 A1
(43) Pub. Date: Sep. 18, 2025

(54) AUTOMATIC HARDWARE-EFFICIENT CIRCUIT-LAYERING USING COUPLING-MAP

(71) Applicant: International Business Machines Corporation, Armonk, NY (US)

(72) Inventors: Priti Ashvin Shah, Basking Ridge, NJ (US); Nicholas Torleiv Bronn, Long Island City, NY (US)

(21) Appl. No.: 18/428,501

(22) Filed: Jan. 31, 2024

(51) Int. Cl. G06N 10/60; G06N 10/20

(52) U.S. Cl. CPC G06N 10/60; G06N 10/20

(57) ABSTRACT

A given algorithm to be implemented on a quantum processor and a coupling map for the quantum processor are obtained. A specified minimum distance between each set of coupling pairs of qubits of the quantum processor needed to satisfy a crosstalk specification of the given algorithm is obtained, the coupling pairs of qubits being defined by the coupling map. A set of layers defining coupling pairs of qubits for implementing the given algorithm on the quantum processor, wherein each layer corresponds to a step in time, is determined. A compressed set of layers of qubit pairs is generated based on the determined set of layers that conforms to the specified minimum distance between each set of coupling pairs of qubits and that reduces an execution time of the given algorithm in comparison to the determined set of layers.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURE: Code containing aspects of this invention was uploaded to a publicly accessible repository (GitHub) on Feb. 19, 2023.

### BACKGROUND

The present invention relates generally to the electrical, electronic and computer arts and, more particularly, to quantum computing.

In quantum computing, coupling maps describe the connectivity of qubits within a lattice representation of a qubit processor. The coupling map contains a list of pairs of connected qubits. The configuration defined by the coupling map specifies the topology of the quantum processor and its number of qubits, which tends to vary for each quantum computer. The quality of the mapping of a given algorithm to the lattice of qubits impacts the execution time of the algorithm as well as the performance of the algorithm. Qubit decoherence, which increases over time, suggests a goal of a faster execution time of an algorithm. On the other hand, crosstalk between qubits operating simultaneously limits the ability to perform operations in parallel (which would serve to reduce circuit execution time).

### BRIEF SUMMARY

Principles of the invention provide systems and techniques for automatic hardware-efficient circuit-layering using a coupling-map. In one aspect, an exemplary method includes the operations of obtaining a given algorithm to be implemented on a quantum processor; obtaining a coupling map for the quantum processor; obtaining a specified minimum distance between each set of coupling pairs of qubits of the quantum processor needed to satisfy a crosstalk specification of the given algorithm, the coupling pairs of qubits being defined by the coupling map; determining a set of layers defining coupling pairs of qubits for implementing the given algorithm on the quantum processor, wherein each layer corresponds to a step in time; and generating a compressed set of layers of qubit pairs based on the determined set of layers that conforms to the specified minimum distance between each set of coupling pairs of qubits and that reduces an execution time of the given algorithm in comparison to the determined set of layers.

In one aspect, a computer program product comprises one or more tangible computer-readable storage media and program instructions stored on at least one of the one or more tangible computer-readable storage media, the program instructions executable by a processor, the program instructions comprising obtaining a given algorithm to be implemented on a quantum processor; obtaining a coupling map for the quantum processor; obtaining a specified minimum distance between each set of coupling pairs of qubits of the quantum processor needed to satisfy a crosstalk specification of the given algorithm, the coupling pairs of qubits being defined by the coupling map; determining a set of layers defining coupling pairs of qubits for implementing the given algorithm on the quantum processor, wherein each layer corresponds to a step in time; and generating a compressed set of layers of qubit pairs based on the determined set of layers that conforms to the specified minimum distance between each set of coupling pairs of qubits and that reduces an execution time of the given algorithm in comparison to the determined set of layers.

In one aspect, an apparatus comprises a memory and at least one processor, coupled to the memory, and operative to perform operations comprising obtaining a given algorithm to be implemented on a quantum processor; obtaining a coupling map for the quantum processor; obtaining a specified minimum distance between each set of coupling pairs of qubits of the quantum processor needed to satisfy a crosstalk specification of the given algorithm, the coupling pairs of qubits being defined by the coupling map; determining a set of layers defining coupling pairs of qubits for implementing the given algorithm on the quantum processor, wherein each layer corresponds to a step in time; and generating a compressed set of layers of qubit pairs based on the determined set of layers that conforms to the specified minimum distance between each set of coupling pairs of qubits and that reduces an execution time of the given algorithm in comparison to the determined set of layers.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment/instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
platform for creating logic for quantum computers that minimizes noise from neighboring qubits (i.e., crosstalk) and creating processor-wide systematic experiments;
algorithms that are sensitive to crosstalk, such as dynamical simulation, may use Trotter step input where the compression into layers yields savings in execution time but is limited by the sensitivity to crosstalk;
ansatz-based algorithms that are insensitive to crosstalk may yield savings in processing times and duration for various tasks, such as the variational quantum Eigensolver (VQE) algorithm, where layered ansatze may be more efficient than linear ansatze; and
algorithmically configure qubit pairs that are at least a fixed distance apart, aiding in the scaling of analog (quantum) algorithms to larger processors.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates an example Algorithm Dependent Qubit Layering (ADQL) mapping for two algorithms, in accordance with an example embodiment;

FIG. 2 illustrates four layers implemented on a heavy hex lattice with a distance of zero where solid barbells represent pairs of coupled qubits for the VQE example, in accordance with an example embodiment;

FIG. 3 illustrates five layers implemented on a heavy hex lattice with a distance of one (at least one qubit between coupled pairs) where solid barbells represent pairs of coupled qubits, in accordance with an example embodiment;

FIG. 4 illustrates six layers implemented on a heavy hex lattice with a distance of two (at least two qubits between coupled pairs) where solid barbells represent pairs of coupled qubits, in accordance with an example embodiment;

FIG. 5 illustrates the generation of adjacency matrices from a graphical representation of qubits, in accordance with an example embodiment;

FIGS. 6-7 illustrates an example workflow for deriving an adjacency matrix from a coupling map, in accordance with example embodiments;

FIGS. 8-9 illustrates an example workflow for sorting coupling pairs to a desired grouping for a layer, in accordance with example embodiments;

FIG. 10 illustrates a workflow for recursive logic, named handle_pair, for searching for potential qubit-pairs that are a specified distance away from the qubit-pair being considered, in accordance with example embodiments;

FIG. 11 illustrates a workflow for logic to determine combined_layers_min, in accordance with example embodiments;

FIG. 12 illustrates a workflow for matrix_compress and n2_compress logic, in accordance with example embodiments;

FIG. 13 illustrates a workflow for the recursive use of the n2_compress logic, in accordance with example embodiments;

FIG. 14 illustrates a workflow for the recursive use of matrix_compress logic, in accordance with example embodiments; and

FIG. 15 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Generally, methods and systems are provided for creating quantum computers using a mapping algorithm (referred to as Algorithm Dependent Qubit Layering (ADQL) herein) that maps a given algorithm to qubits of a specified quantum lattice using a coupling map. In one example embodiment, a distance between qubit pairs is a selectable constraint (referred to as “distance” and n herein) on the ADQL mapping, such that crosstalk is limited to a level suitable for the given algorithm. (It is noted that quantum simulation is generally sensitive to crosstalk whereas a variational quantum Eigensolver (VQE) is generally not sensitive to crosstalk.) The ADQL mapping algorithm also maps the given algorithm such that the given algorithm is optimized to execute in a minimal amount of time, thereby improving performance of the quantum computer and reducing the probability of decoherence occurring during the performance of the given algorithm. (As used herein, a quantum circuit relates to the implementation of a quantum algorithm whereas a quantum device is the physical device that consists of the qubits.)

As used herein, a coupling map describes the connectivity of the qubits and is obtained, for example, from a quantum computer's configuration. In one example embodiment, the coupling map contains a list of pairs of connected qubits. This configuration specifies the topology of the quantum processor and its number of qubits, which tends to vary for each quantum computer.

Init_layout contains the identifiers, qubit_ids, of the physical qubits within the coupling map which are desired for execution. The init_layout can be all of the qubits or a subset of available qubits from the coupling map. In one example embodiment, if a priori knowledge regarding specific unusable qubits (such as qubits which are not stable, not behaving as expected, and the like) is available, the unusable qubits are excluded from init_layout. In one example embodiment, the qubits with the least amount of average two-qubit error (compatible with the minimum number of SWAP gates needed to implement the algorithm) are selected for the init_layout by, for example, using a graph-related algorithm.

As used herein, distance is the minimum number of qubits guaranteed to reside between pairs of coupled qubits and defaults to zero. This number is related to the exponent, qubit_distance, of the adjacency matrix where qubit_distance is equal to distance+2. A distance of zero means the pairs can be adjacent to each other (i.e., an unused pair exists within the coupling map where the unused pair includes one qubit from each pair under consideration). One means there is a minimum of one qubit between pairs of coupled qubits, and so on. Two overlapping qubits (that is, sharing a qubit_id) is not permitted because it would interfere with the operation of those pairs.

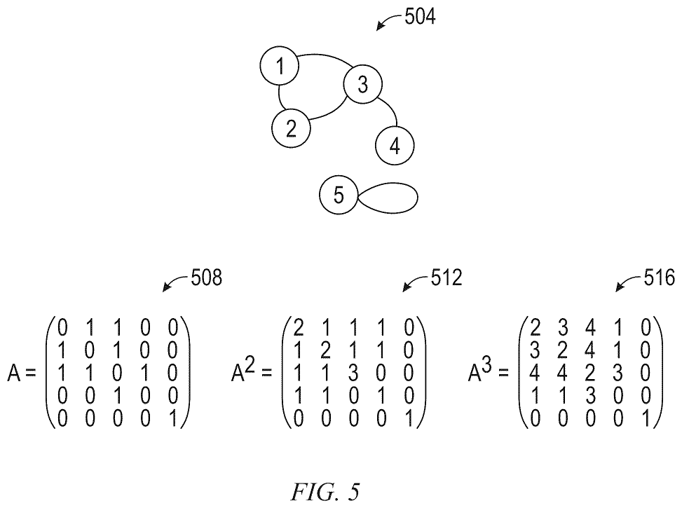

Entangling_dict is a dictionary that contains a key and value for only qubits from init_layout which are desired. In one example embodiment, the list is sorted by both the first and second qubit pairs, and the desired qubits are formatted within an adjacency matrix, as described below in conjunction with FIG. 5, and multiplied qubit_distance times. The number in the matrix corresponds to how many paths in the graphs connect the two qubits. The distance between qubits (that is, n) is used to determine the matrix exponent (that is, n+2, denoted by qubit_distance). Using the adjacency matrix, the intermediate results of the matrix multiplication, that is, A, A², . . . , Aⁿ⁺² (denoted by entangled_result) are maintained. Aⁿ⁺² is used to populate entangling_dict, where the key is each qubit of interest and the value is the list of qubits which are at least distance away. The intermediate matrices are maintained for checking if a qubit pair can be added to a layer. Within the result of the matrix multiplication, qubits with a “1” entry within the matrix, which are not on the diagonal, are used. This guarantees that there is only one path connecting unique qubits, meaning they are the desired distance from each other in the qubit topology. As noted above, the number in the matrix corresponds to how many paths in the graphs connect the two qubits and, thus, the number can be greater than one.

As used herein, a layer is a set of pairs of coupled qubits. All the qubit pairs from the init_layout are divided into layers so that the pairs of qubits are at least a specified distance (distance) apart. A set of layers is defined to include all the qubits of interest (also referred to an entanglement map herein). A set of compressed layers is the result of combining the set of layers such that qubit pairs are at least the specified distance apart, where one goal is to minimize the count of layers.

### Algorithm Dependent Qubit Layering (ADQL)

In one example embodiment, qubit topologies are designed based on quantum error correction codes, where algorithms to be executed are first mapped to a target lattice of qubits. A variety of topologies of qubits may be utilized; one of the considered topologies of a target lattice is different from the standard “linear,” “circular,” or “all-to-all” connectivity of conventional lattices. The ADQL mapping algorithm considers how to best use the topology of qubits to implement a given algorithm, such as layers of VQE (Ansatz) or quantum simulation (Trotter step).

### Initial Aspects: Correlation to Coupling Map

Given a coupling map for the backend of a quantum computer, a compressed set of layers that conforms to a specified “distance” between the desired qubits is generated such that users can choose what is best based on the quantum algorithm of interest. For example, the minimum number of layers that can be attained, subject to the constraint of crosstalk that may arise from compressing them, may be chosen by the user. As noted above, different lattices may be selected. For example, a different lattice may be selected by moving from a surface code to a heavy hex code, where connectivity is dropped from the four nearest neighbors to two to three nearest neighbors (impacting the degree of the corresponding graph). Low-density parity check codes, where each vertex has six nearest neighbors and two of the qubits are long-range neighbors, are also considered.

In one example embodiment, the selected lattice is configured for supporting a chosen Quantum error correction code. A surface code is defined for a square lattice where every qubit is attached to its nearest neighbor (as reflected by coupling maps). (Two qubit operations are performed between coupled qubits.)

In one example embodiment, the selected lattice is configured for supporting a variational quantum Eigensolver implemented with a circuit that performs essentially as a parameterized guess and attempts to optimize over the parameters of the guess to change the values of the parameters to achieve a lowest value of a cost function. Informed VQEs can have knowledge about the physical system, but it is often desirable to do what is efficient and enter what the lattice is, that is, the entanglement required by the Ansatz can be specified similar to the lattice in that the qubits that are next to each other are entangled instead of entangling qubits that are some distance apart (otherwise, SWAPs (of the quantum information between the qubits) are required, which increases the depth, thereby increasing the number of layers and increasing the error). The use of a classical optimizer for optimizing the parameters means there is no issue with coherent error; crosstalk essentially does not matter because the coherent error can be taken care of by the classical optimizer. For VQE-type algorithms, the use of a compressed set-of-layers is more efficient due to the robustness of the algorithm to crosstalk. For the Trotterized algorithm, the circuit evolves in time and, while the circuit can be segmented into smaller pieces, more pieces means more errors.

For simulation-type circuits, initial evidence indicates that a spacing of qubits between pairs could improve the result of the simulations due to their sensitivity to crosstalk. The disclosed circuit-layering algorithm aids this constraint in a scalable way.

### ADQL Mapping

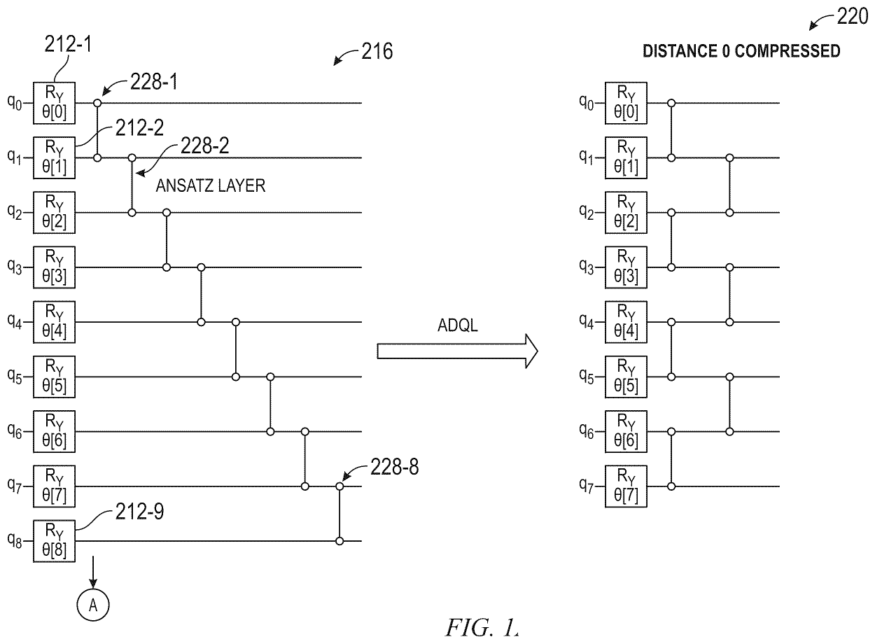

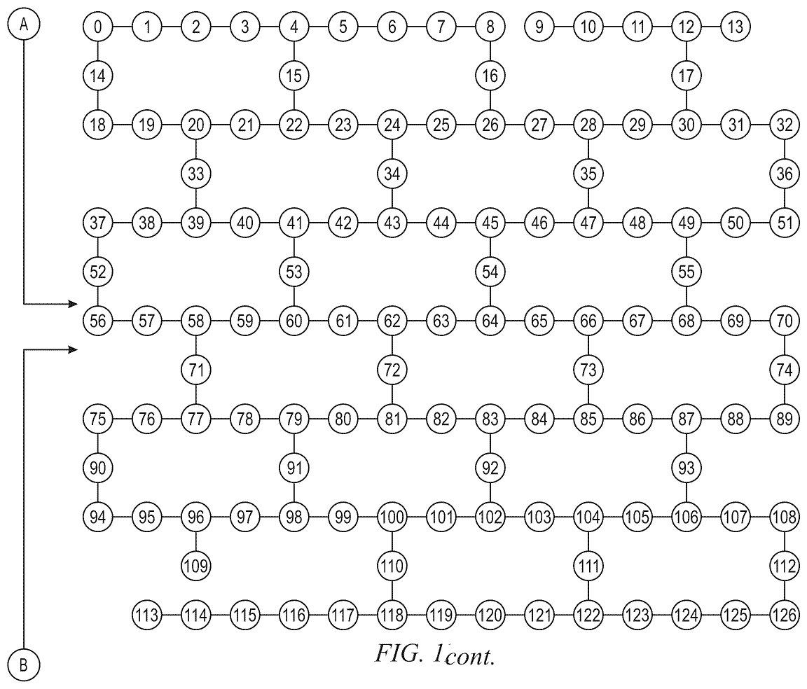

FIG. 1 illustrates an example ADQL mapping for two algorithms, in accordance with an example embodiment. Referring to the upper mapping of FIG. 1, qubits q₀, q₁, . . . , q₈ are represented on the left side of the uncompressed quantum circuits. Single qubit gates 212-1, 212-2, . . . , 212-9 perform single qubit operations, followed by two qubit (entangling) gates 228-1, 228-2, . . . , 228-8, which perform two qubit operations and are more susceptible to crosstalk. The upper mapping of FIG. 1 was performed with a distance of 0, meaning there are no qubits q₀, q₁, . . . , q₈ positioned between the entangling operations.

Referring to the lower mapping of FIG. 1 (Trotter steps), qubits q₁, q₂, . . . , q₁₀ are represented on the left side of the uncompressed quantum circuits. Two qubit (entangling) gates 224-1, 224-2, . . . , 224-9 perform two qubit operations and are more susceptible to crosstalk. The lower mapping of FIG. 1 was performed with a qubit_distance of 1 (distance=2) due to crosstalk sensitivity of the algorithm, meaning there are one or more qubits q₀, q₁, . . . , q₈ positioned between the entangling operations. One goal of the mappings of FIG. 1 is to produce a coupling map with the minimal number of layers to reduce the processing time of the given algorithm. The result of the mapping of the upper instance of FIG. 1 is a coupling map with two layers and the result of the mapping of the lower instance of FIG. 1 is a coupling map with three layers.

It is noted that each depth of Ansatz and Trotter step are layers (where each Ansatz and Trotter step corresponds to a plurality of entangling layers). The Ansatz layer 216 illustrates the coupling between ten qubits over a period of time (eight entangling layers). An example ADQL mapping 220 generated for a distance of 0 shows two layers for a heavy hex lattice.

As noted above, VQE is generally insensitive to crosstalk and can generate more entanglement per entangling layer; that is, it can operate on adjacent pairs of qubits. Quantum simulation is sensitive to crosstalk and, therefore, it is desirable to have space between adjacent pairs of qubits. ADQL can yield savings in times and duration for VQE. ADQL also solves the challenges using adjacency matrices with two recursive algorithms.

### VQE Example

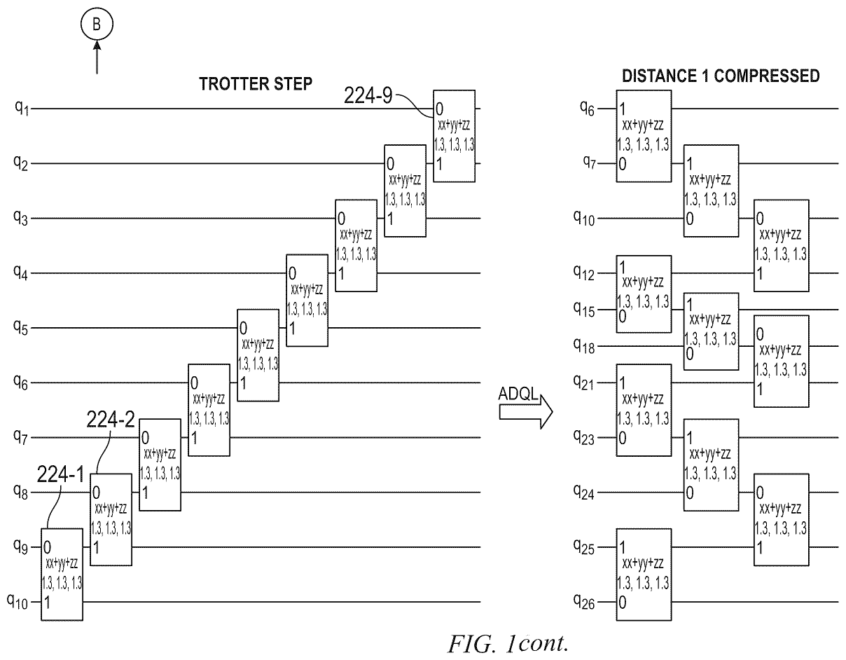

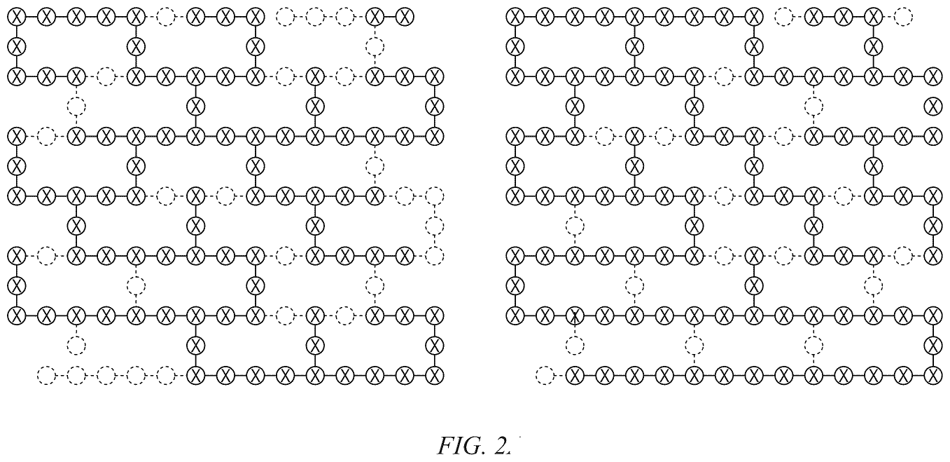

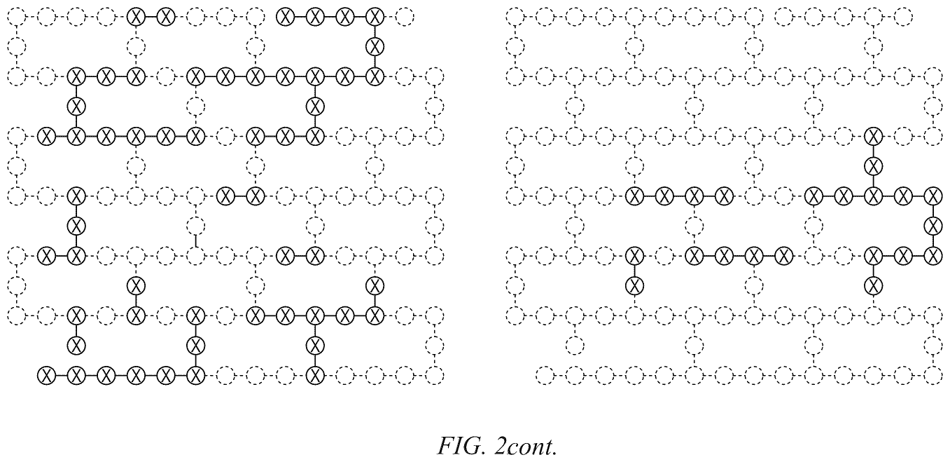

FIG. 2 illustrates four layers implemented on a heavy hex lattice with a distance of zero where solid barbells represent pairs of coupled qubits for the VQE example, in accordance with an example embodiment. The minimum distance between coupled qubits may be specified based on the sensitivity of the given algorithm to crosstalk. Thus, algorithms with little or no sensitivity to crosstalk can utilize a distance of zero (meaning coupled qubits may be located next to each other) whereas algorithms with sensitivity to crosstalk utilize a distance of x, where x is greater than zero and where coupled qubits have a minimum of x qubits between each pair of coupled qubits.

### Quantum Simulation Example

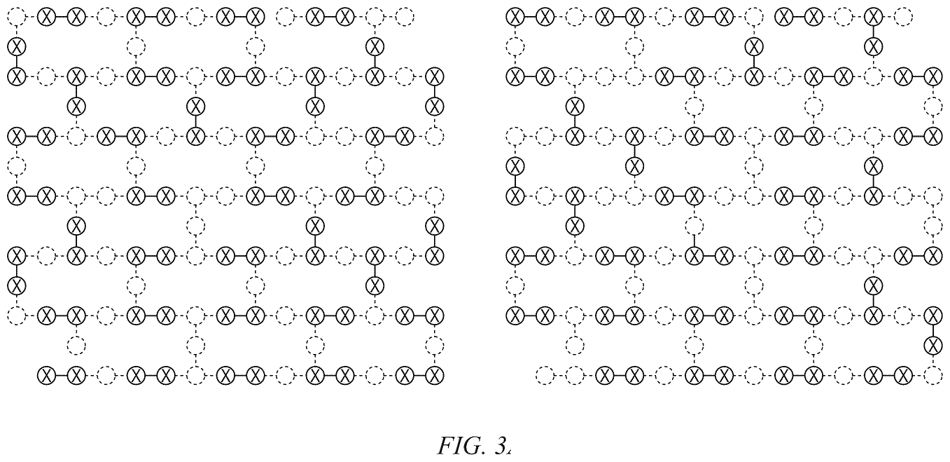

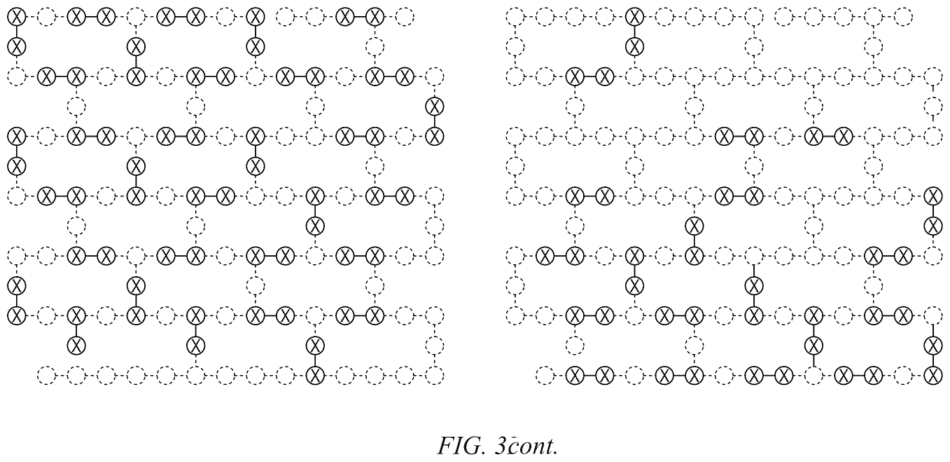

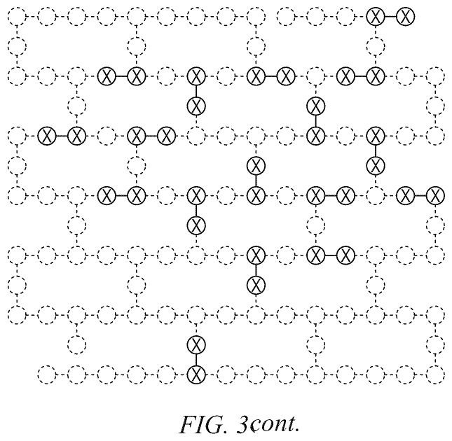

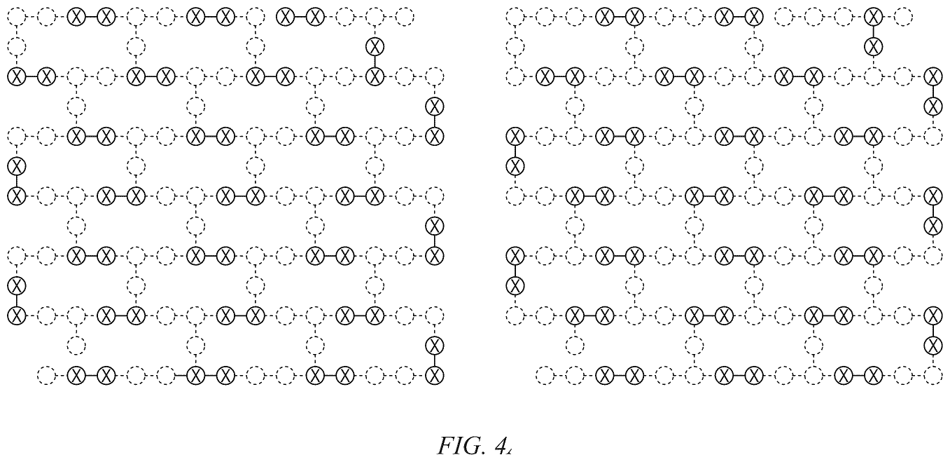

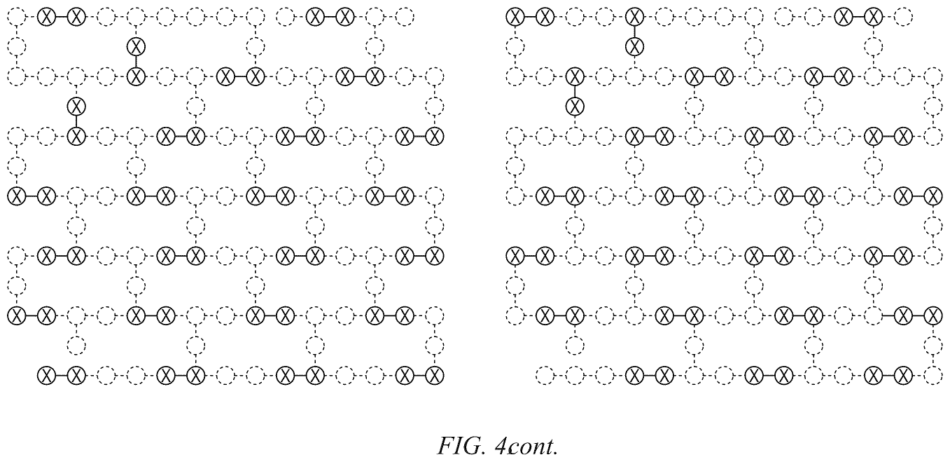

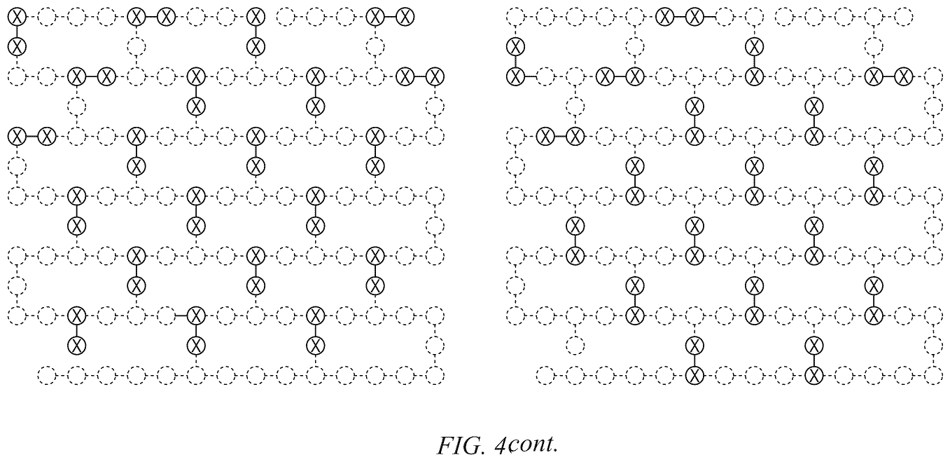

FIG. 3 illustrates five layers implemented on a heavy hex lattice with a distance of one (at least one qubit between coupled pairs) where solid barbells represent pairs of coupled qubits, in accordance with an example embodiment. FIG. 4 illustrates six layers implemented on a heavy hex lattice with a distance of two (at least two qubits between coupled pairs) where solid barbells represent pairs of coupled qubits, in accordance with an example embodiment.

### Automatic Generation of a Solution Set of Compressed Sets-of-Layers

### High-Level Flow: Graph Theory Techniques With Two Recursive Algorithms

FIG. 5 illustrates the generation of adjacency matrices 508, 512, 516 from a graphical representation 504 of qubits, in accordance with an example embodiment. In the example of FIG. 5, each row and each column of the matrix A 508 corresponds to a qubit of the graph 504. For example, the top row corresponds to qubit 1 and the left-most column corresponds to qubit 1. Similarly, the bottom row corresponds to qubit 5 and the right-most column corresponds to qubit 5. As illustrated in matrix A 508, qubit 1 is connected to qubit 2 and qubit 3, as indicated by the value of one in column 2 and column 3 of the top row of the matrix A 508. Matrices 512 and 516 represent A² and A³, respectively. In one example embodiment, either a symmetric or asymmetric adjacency matrix A 508 is generated from a coupling map for the desired qubits. The distance between qubits, i.e. n, is used to determine the matrix exponent, where the matrix exponent is n+2 (denoted by qubit_distance). The desired adjacency matrix A 508 and intermediate matrix multiplications are generated using qubit_distance. Intermediate results of matrix multiplication, i.e., A, A², . . . , Aⁿ⁺² (denoted by entangled_result), are maintained using the adjacency matrix A 508. Aⁿ⁺² is used to populate entanglement_dict, where the key of the entanglement_dict dictionary is each qubit of interest and the value of entanglement_dict is a list of qubits which are at least distance away. Intermediate matrices are maintained for checking if a qubit pair can be added to a layer.

After entangling_dict is generated, each key in entanglement_dict is looped through, in order to generate a set of layers, where unique sets of layers are kept. For each unique set, layers are combined using the intermediate matrices to determine if the qubits are equal to or greater than distance apart. The sets with the minimum number of layers are kept.

In one example embodiment, a coupling map is initially input from, for example, a quantum backend. A list of desired qubits is identified or an indication to use all qubits of the quantum backend is issued. The qubit_distance between pairs is also denoted.

The output generated includes the solution set of the compressed sets-of-layers where the set of layers uses all the available pairs of desired qubits.

### ADQL Algorithm

In one example embodiment, a recursive mapping algorithm uses adjacency matrices to perform the ADQL algorithm, recursively adding pairs of qubits to each layer and making sure the qubits pairs are at least the specified distance from each other. (Recursive logic is not needed when distance is set to zero.) It is noted that all layers can be generated and then compressed, or each layer can be compressed as it is created.

In one example embodiment, the adjacency matrix A 508 and the intermediate matrices are used for both sets of recursive logic (the logic can be sequential or performed in a partially parallel manner). The first set of recursive logic determines the coupling pairs of qubits by using the adjacency matrix A 508 (which can be within one layer). (The intermediate matrices are used to check if the coupling pairs circle back on themselves, that is, if the “edges” that connect “nodes” representing the qubits return to the original pair of qubits.) Then, layers are generated until all pairs of qubits are used.

The second set of recursive logic combines the layers and is based on the distance between qubits. Two different types of logic can be used to combine layers, depending on the specified distance:
1) for adjacent qubits with the distance set equal to 0, the adjacency matrix A 508 does not need to be checked; only need to check if the pair of qubits has been assigned to a layer; and
2) for adjacent qubits with the distance set to a number greater than 0, the adjacency matrix A 508 and intermediate matrices are used to determine if the layers can be combined.

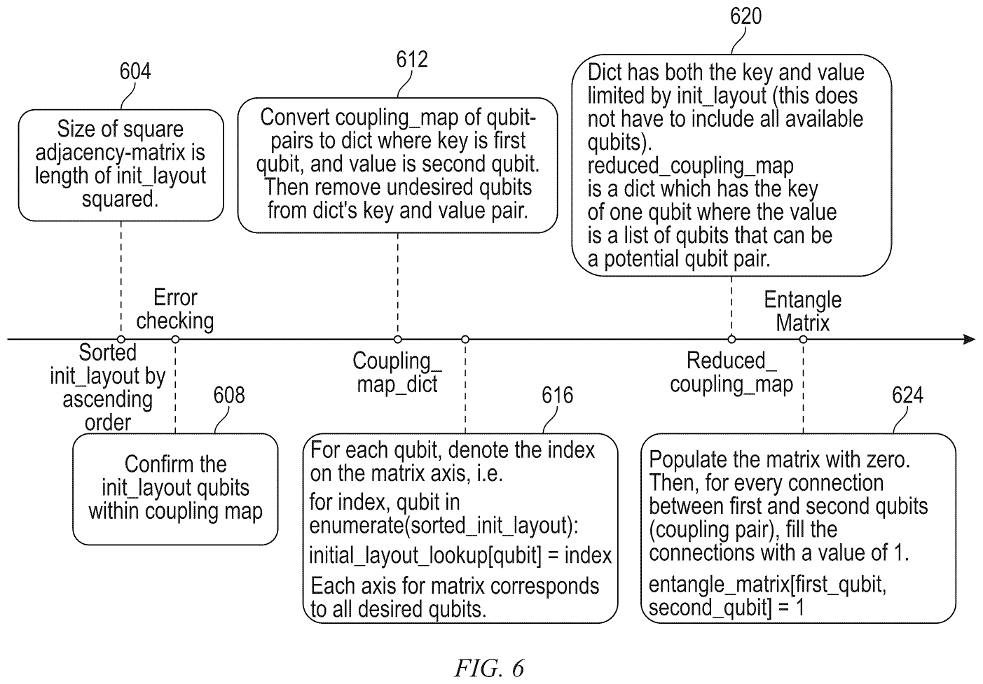

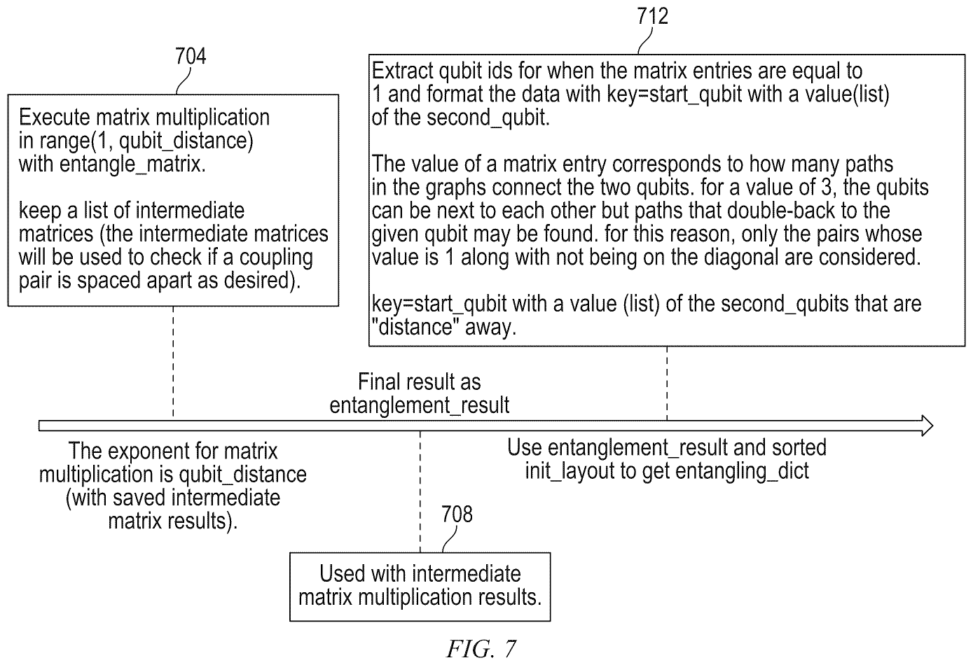

FIGS. 6-7 illustrate an example workflow for deriving an adjacency matrix 508 from a coupling map, in accordance with example embodiments. The coupling map workflow is based on init_layout, and results in the generation of the adjacency matrix 508 and the entangling_dict dictionary. An initial layout (init_layout), which contains the identification (qubit_ids) of the physical qubits within the coupling map which are desired for execution (such as all qubits, excluding the unusable qubits), is sorted by ascending order. A size of a square adjacency matrix A 508, equal to the square of the length of init_layout, is determined based on qubit_distance (operation 604). The init_layout qubits within the coupling map are confirmed using known techniques (error checking; operation 608). For example, the existence of a specified qubit can be confirmed, error characteristics of qubits can be accessed and considered, and the like.

The coupling map of qubit pairs is converted to coupling_map_dict where each key of coupling_map_dict is the first qubit of the pair and the value of coupling_map_dict is the second qubit of the pair. Then the undesired qubits are removed from coupling_map_dict's key and value pairs (operation 612).

For each qubit, denote the index on the matrix axis, i.e. for index, qubit in enumerate(sorted_init_layout): initial_layout_lookup[qubit]=index (operation 616). Each axis for the matrix A 508 corresponds to all of the desired qubits. In other words, given the sorted initial list, sorted_init_layout, the index within the list and the value of each qubit are obtained. The initial layout lookup dictionary, initial_layout_lookup, is then populated where the key corresponds to the qubit and the value corresponds to the index.

The generated coupling_map_dict has both the key and value as limited by init_layout. In other words, coupling_map_dict does not have to include all available qubits, but can be limited to the qubits in the init_layout. A reduced coupling map is a dictionary (dict) which has the key of one qubit and a value that is a list of qubits that can be a potential pair with the qubit of the key.

The adjacency matrix A 508 is initially populated with zero. Then, for every connection between first and second qubits (a coupling pair), the connections are filled with the value of one, that is, entangle_matrix[first_qubit, second_qubit]=1 (operation 624). In other words, the entangle matrix, entangle_matrix, is populated using the concepts illustrated in FIG. 5 during operations 616-624. The rows and columns of the adjacency matrix 508 are the qubits that are denoted from the sorted initial layout, sorted_init_layout. It is noted that the qubits have been sorted by ascending order. A value of one is entered to denote a connection between two qubits; otherwise, the matrix will have a value of zero.

Referring to FIG. 7, matrix multiplication (operations 704-708) is executed in the range(1, qubit_distance) with entangle_matrix, in accordance with example embodiments. A list of intermediate matrices is maintained since the intermediate matrices will be needed to check if the coupling pair is spaced at least the specified distance apart (operation 704). The exponent for the matrix multiplication is the qubit_distance with the saved intermediate matrix results. The final result, defined as entanglement_result, is obtained for use with the intermediate matrix results (operation 708).

The entanglement_result and sorted init_layout are used to generate entangling_dict. Qubit IDs (the axis and columns of the matrix which refer to the qubits that were part of the sorted initial layout and correspond to the entangle matrix) are extracted from the sorted initial layout, sorted_init_layout, when the matrix entries are equal to one and the data is formatted with key=start_qubit with a value(list) of the second_qubit (operation 712). Operation 712 is the reading of the matrix after the multiplication. For example, consider one row of the matrix, corresponding to variable qubit1. The qubits that are connected to qubit1, denoted as qubit2, can be identified by determining which other qubits have a value of one in the given row. When there is a value one in a column, this information is stored in, for example, a Python dictionary having a dictionary structure of a key and a value. The key is the qubit which corresponds to the row. The value to be stored is a list of the qubits connected to qubit1. Thus, to denote a qubit2, inspect the value for each column and, if the value is a one, add qubit2 to the list.

The value of the matrix entry corresponds to how many paths in the graphs connect the two qubits. For a value of 3, then, the qubits could be next to each other because it is always possible to find paths that double-back to the qubit in question (e.g., edge from the original qubit to an adjacent qubit, edge back to the original qubit, same edge from the original qubit to an adjacent qubit and the like). For this reason, it is important, in one or more embodiments, to only consider the pairs of qubits whose value is one, along with not being on the diagonal.

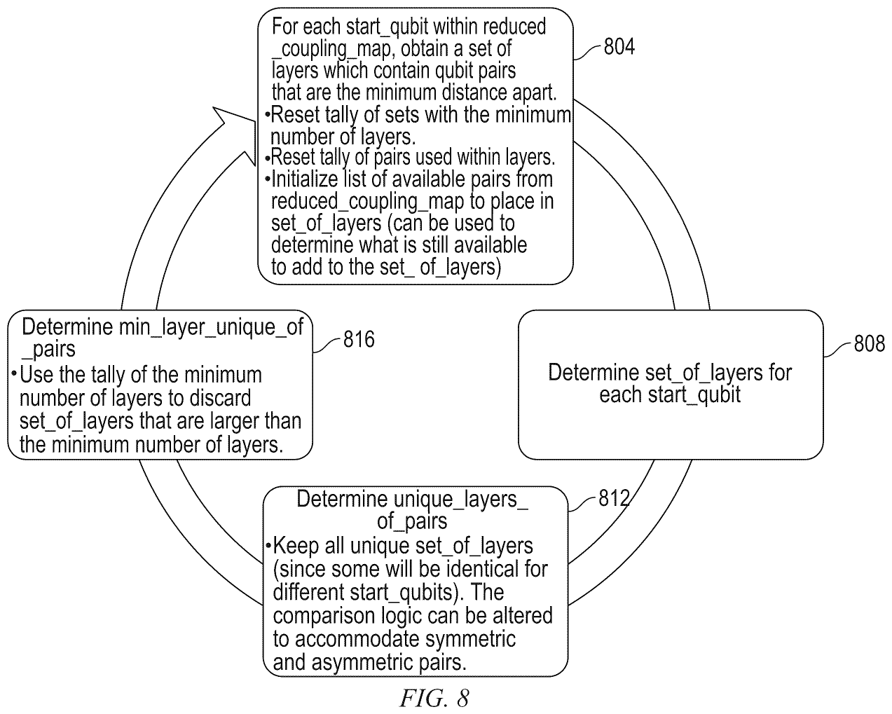

FIG. 8 illustrates an example workflow for sorting coupling pairs into a desired grouping of qubit pairs for a layer, in accordance with example embodiments. For each qubit (start_qubit) within the reduced coupling map, obtain a set of layers which contain pairs of qubits that are, at a minimum, distance apart. A tally of sets having a minimum number of layers is reset, a tally of pairs of qubits used within any of the layers is reset and a list of available pairs of qubits identified by the reduced coupling map is initialized for placement of the available qubits into a layer of the set_of_layers (the list of available pairs of qubits is used to determine what is still available to add to a layer of the set_of_layers) (operation 804).

The set_of_layers for each start_qubit is determined (operation 808). The corresponding logic is described below in conjunction with FIG. 9.

Unique_layers_of_pairs is determined (operation 812). In one example embodiment, one set of layers is compared to all of the other sets of layers. If a match is found, only one of the matching sets is kept. All unique set_of_layers are maintained since some will be identical for different start_qubits. The comparison logic can be altered to accommodate symmetric and asymmetric pairs.

Min_layer_unique_layer_of_pairs is determined (operation 816). Each solution set_of_layers has an associated count of layers. A tally of the minimum number of layers of the sets is maintained. The tally of minimum number of layers is used to discard any set_of_layers that are larger than the minimum number of layers, that is, if the number of layers in unique_layers_of_pairs has more layers than the minimum tally, then that set_of_layers is discarded. The process then proceeds with operation 804 and ends once each start_qubit has been processed.

combined_layers_min contains only the solution sets having the minimum number of layers. The logic is described below in conjunction with FIG. 11. The logic can be executed sequentially or within the logic of obtaining set_of_layers for each start_qubit. The logic can be optimized based on distance.

Efficiency logic is based on whether the desired result (solution) is to derive a single set_of_layers or to derive a solution that includes all set_of_layers that have the determined minimum number of layers, that is, the logic can be varied based on the desired efficiency. This logic is applied to either min_layer_unique_of_pairs to get at least one set of layers OR to unique_layers_of_pairs to obtain most possible sets (the set_of_layers generated for each starting qubit, excluding duplicate set_of_layers and sets of repeated layers).

Referring now to FIG. 9, each qubit of the reduced coupling map and the qubits connected to it are iterated through (operation 904).

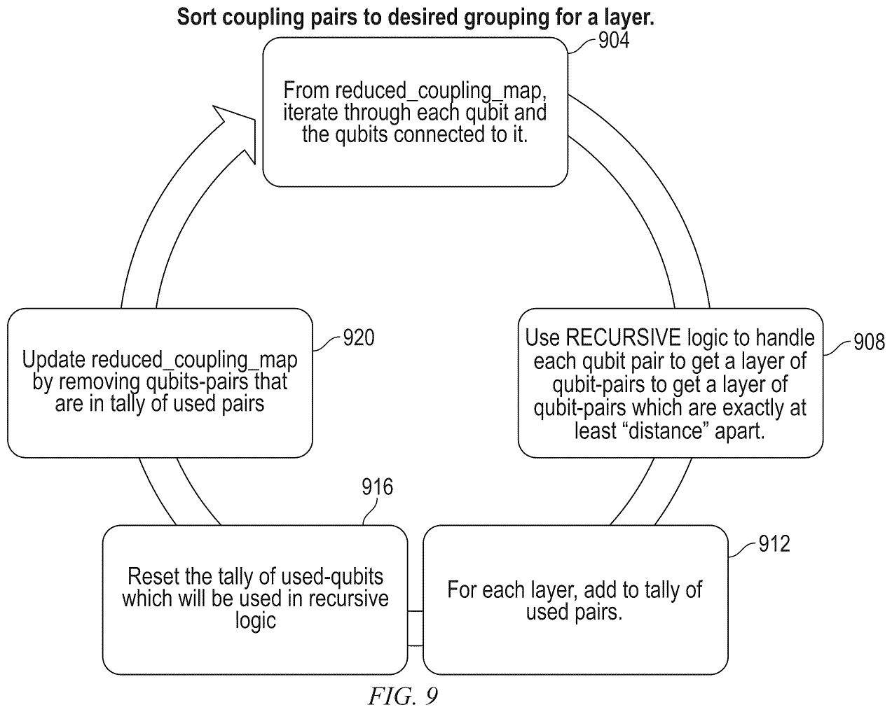

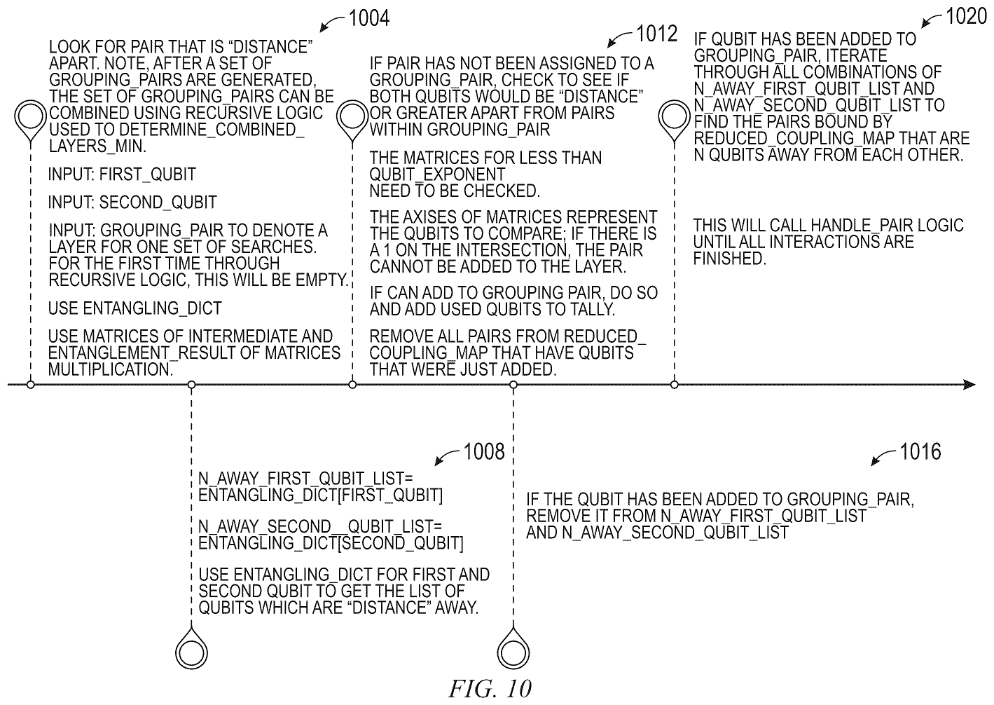

RECURSIVE logic is used to handle each pair of qubits to get a layer of qubit pairs (grouping_pair) which are exactly at least distance apart, as described below in conjunction with FIG. 10. (Operation 908.)

For each layer, add to the tally of used pairs of qubits (used-pairs) (operation 912).

The tally of used qubits, used-qubits, which will be used in the recursive logic, is reset (operation 916).

The reduced coupling map is updated by removing qubit pairs that are in the tally of used pairs, used-pairs (operation 920). The process then proceeds with operation 904 and ends when the iterating through each qubit (and qubit connected to it) is complete.

FIG. 10 illustrates a workflow for recursive logic, named handle_pair, for searching for potential qubit-pairs that are at least a specified distance away from the qubit-pair being considered, in accordance with example embodiments. The next qubit-pair is then recursively searched for until no pairs of qubits are available for search.

In one example embodiment, a search for a pair of qubits that is at least the specified distance from the qubit pair being considered is conducted (operation 1004). Note that, after a set of grouping pairs (grouping_pairs), where each grouping_pair denotes a set of qubit pairs for one layer after one set of searches, are generated, they can be combined using the recursive logic to reduce the set of layers and to determine combined_layers_min. To accomplish the reduction, one layer is selected and compared to another layer to see if the qubit pairs would still be the specified distance apart when the layers are overlayed (and, potentially, combined). If the qubit pairs would still be at least the specified distance apart when the layers are overlayed, the two layers can be combined into a new set of grouping_pairs. The combined layer is then compared to all the other layers to determine if there can still be more coupling-pairs added to the new grouping_pair. This process continues until the selected layer is compared to all the other layers, resulting in the minimal number of combined layers (combined_layers_min). The input to the process includes first_qubit, second_qubit and grouping_pair to denote a layer for one set of searches. For the first time through recursive logic, grouping_pair will be empty. Entangling_dict, the intermediate matrices and entangled_result are used here to generate the grouping pairs. In one example embodiment, the entangling dictionary, entangling_dict, for the first qubit and second qubit is accessed to obtain the list of qubits which are at least the specified distance away (operation 1008):

n_away_first_qubit_list=entangling_dict[first_qubit]

n_away_second_qubit_list=entangling_dict[second_qubit]

If a pair of qubits has not been assigned to a grouping_pair, a check is performed to see if both qubits would be the specified distance or greater apart from pairs of qubits within grouping_pair (operation 1012). The matrices for less than qubit_exponent need to be checked as the axes of the matrix represent the qubits to compare; if there is a value of one on the intersection, the pair of qubits cannot be added to the layer. If the pair of qubits can be added to the grouping pair, the addition is performed and the added qubits are added to the tally of used qubits. All pairs of qubits from the reduced coupling map that have qubits that were just added are removed from reduced_coupling_map, n_away_first_qubit_list and n_away_second_qubit_list. If the qubit has been added to grouping_pair, it is removed from n_away_first_qubit_list and n_away_second_qubit_list, the lists of qubits that are at least distance away from the given qubit pair (operation 1016).

If a qubit has been added to grouping_pair, all combinations of n_away_first_qubit_list and n_away_second_qubit_list are iterated through to find the pairs bound by the reduced coupling map that are at least a distance of n away from each other. This calls handle_pair logic until all iterations are finished. (Operation 1020.)

FIG. 11 illustrates a workflow for logic to determine combined_layers_min, in accordance with example embodiments.

For every set_of_layers within unique_layers_of_pairs (input 1104), operations 1108 through 1120 are repeated. One goal of the logic of FIG. 11 is to combine layers that have qubit_pairs that are more than the specified distance apart and that do not repeat qubits when combined.

The set_of_layers is sorted from the greatest number of pairs to the least number of pairs, defined as temp_sorted_by_len (operation 1108).

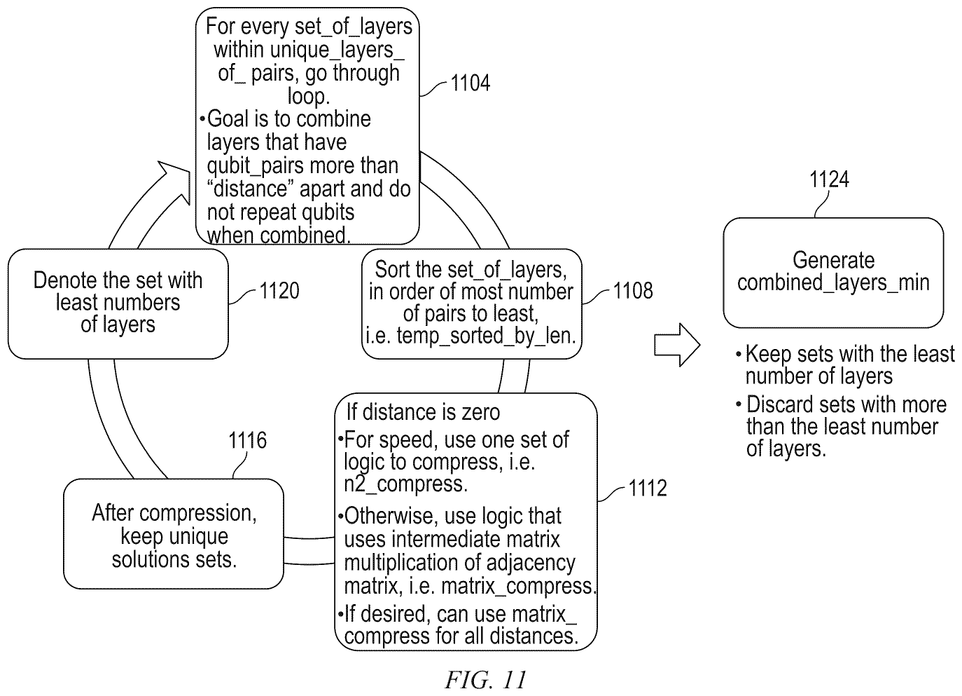

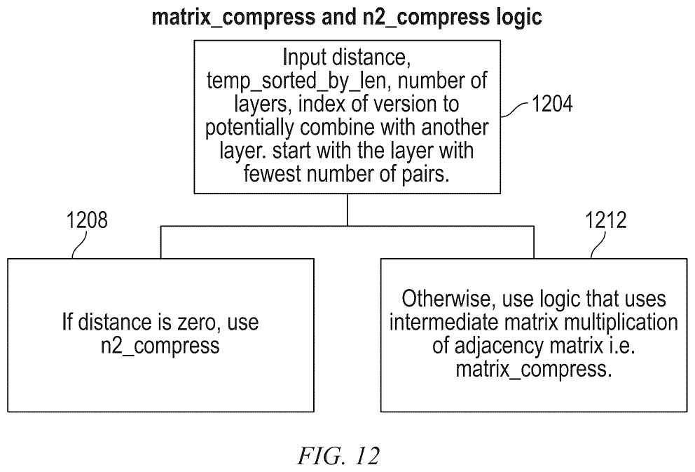

If distance is set to zero, for speed, use one set of logic to compress layers, i.e. n2_compress; otherwise, use logic that uses intermediate matrix multiplication of adjacency matrix, i.e. matrix_compress. If desired, can use matrix_compress for all distances (operation 1112), although this technique can be less efficient than n2_compress. (See FIG. 12.)

After compression, keep the unique solution sets (operation 1116) and denote the set having the least number of layers (operation 1120). Generate combined_layers_min based on the set having the least number of layers (operation 1124); that is, keep sets of layers with the least number of layers and discard sets with more than the least number of layers.

FIG. 12 illustrates a workflow for matrix_compress and n2_compress logic, in accordance with example embodiments.

In one example embodiment, the input includes distance, temp_sorted_by_len, the number of layers, and an index of version to potentially combine with another layer (as part of combining the greatest possible number of layers together, indexing is used to keep track of the intermediate combined layers along with remaining layers to consider to combine). The layer with the fewest number of qubit-pairs is initially started with (operation 1204).

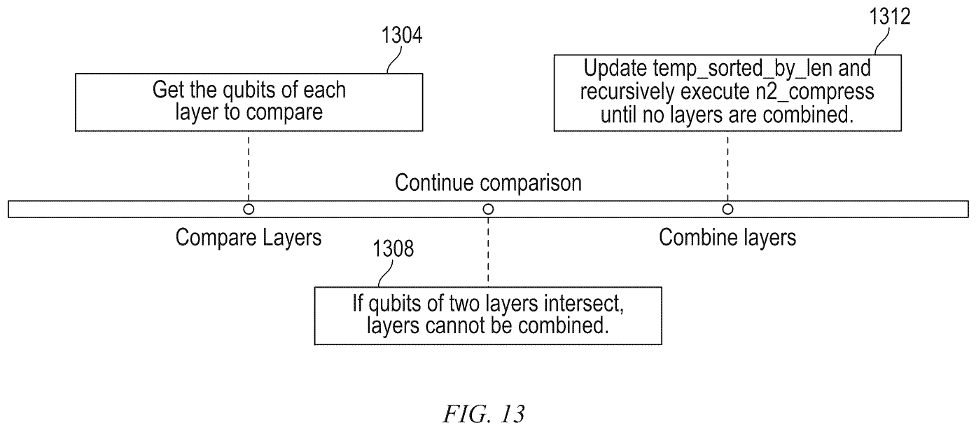

If distance is specified as zero, the n2_compress logic is performed (operation 1208; see FIG. 13); otherwise, logic that uses intermediate matrix multiplication of the adjacency matrix, i.e. matrix_compress, is performed (operation 1212; see FIG. 10). (It is noted that n2_compress logic is faster than matrix_compress, but can only be used when distance is specified as zero. While matrix_compress may be used when distance is specified as zero, it is less efficient in this case than n2_compress.)

FIG. 13 illustrates a workflow for the recursive use of the n2_compress logic, in accordance with example embodiments. For each layer in temp_sorted_by_len, compare the given layer to other layers and test if the qubit-pairs are zero distance apart or greater than zero distance apart.

In one example embodiment, the qubits of each layer to compare are obtained (operation 1304).

A determination is made of whether the layers can be combined. If qubits of two layers intersect, the layers cannot be combined (operation 1308).

temp_sorted_by_len is updated and n2_compress is recursively executed until no more layers are combined (operation 1312).

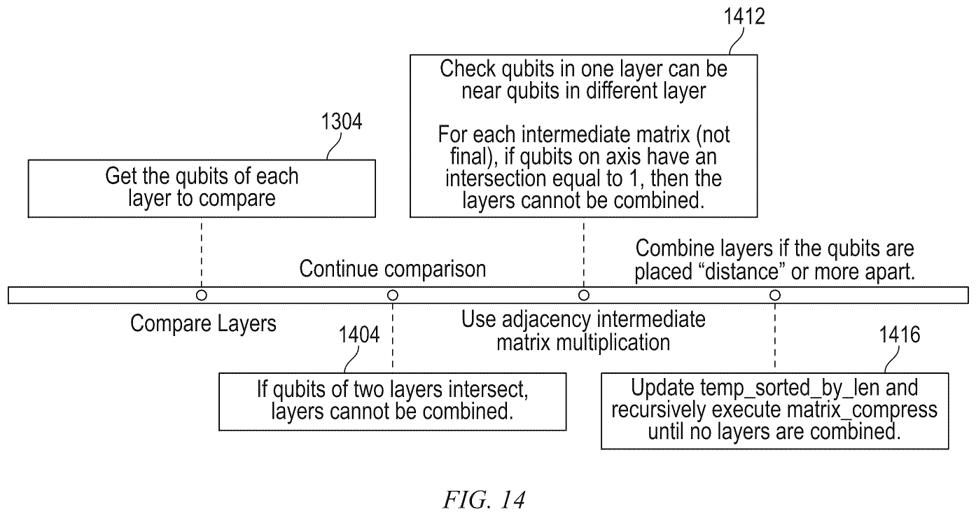

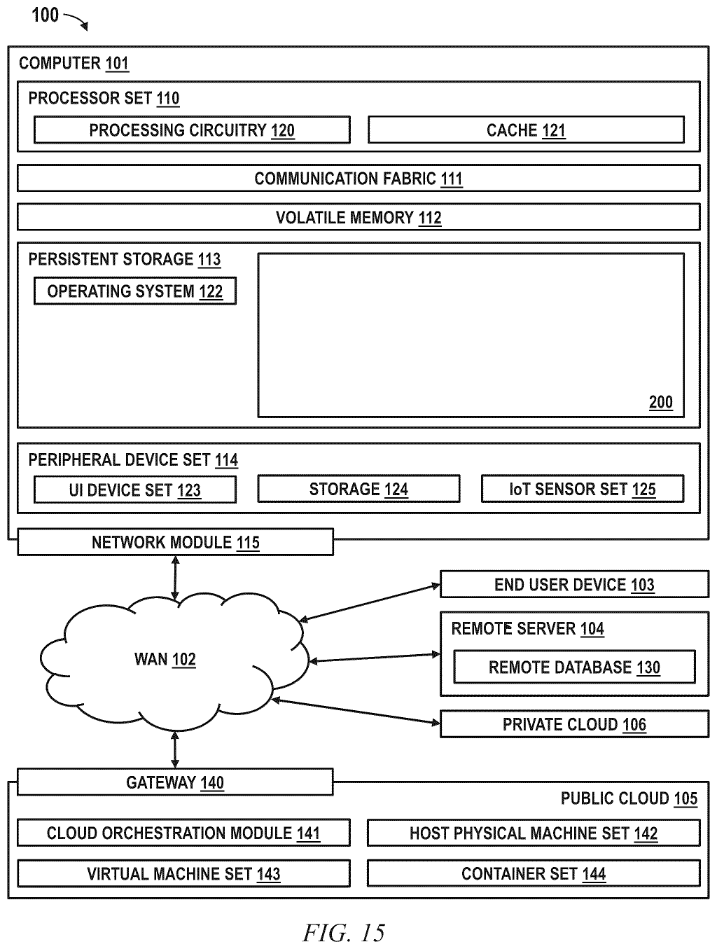

FIG. 14 illustrates a workflow for the recursive use of matrix_compress logic, in accordance with example embodiments. For each layer in temp_sorted_by_len, compare the given layer to other layers and test if the qubit-pairs are zero distance apart or greater than zero distance apart using the intermediate matrices.

In one example embodiment, the qubits of each layer are obtained for comparison (operation 1304).

A determination is made of whether the layers can be combined. If qubits of two layers intersect, the layers cannot be combined (operation 1404).

A check is performed to determine if qubits in one layer can be near qubits in a different layer. For each intermediate matrix (not final), if qubits on an axis have an intersection equal to one, then the layers cannot be combined (operation 1412).

temp_sorted_by_len is updated and matrix_compress is recursively executed until no layers are combined (operation 1416).

### Visualize Flow

The ADQL algorithm can be implemented, for example, with a sequential flow or with one recursive algorithm within another recursive algorithm. In the sequential flow, recursive code using adjacency matrices generate the multiple solution sets of layers. For each solution set, the layers are compressed using the adjacency matrix or simple compression for adjacent pairs.

In the latter flow, recursive code using adjacency matrices generate the multiple solution sets of layers. Within the making of one set of layers, the layers are compressed using the adjacency matrix or simple compression for adjacent pairs.

### Alternate Logic

### Symmetric vs Asymmetric Coupling Pairs From Coupling Map

To accommodate asymmetric pairs from the coupling map, the above-described algorithms are performed similarly, but each pair of qubits is treated as unique, so a qubit-pair cannot be flipped when comparing pairs. In other words, (first_qubit, second_qubit) is not equal to (second_qubit, first_qubit).

When distance is set to zero, the adjacency matrix does not need to be checked for any distance equal to 0; all that is needed is to check if the pair of qubits has been assigned to a layer. However, logic could use the intermediate matrices for all distance values.

### Solution of Combined Layers Min

Logic can be executed as sequentially OR within logic of obtaining dict_of_layers_of_pairs, or equivalently, within logic of obtaining the set_of_layers for each start_qubit (see, FIG. 8). Can be optimized based on qubit_distance.

Given the discussion thus far, it will be appreciated that, in general terms, an exemplary method, according to an aspect of the invention, includes the operations of obtaining a given algorithm to be implemented on a quantum processor; obtaining a coupling map for the quantum processor; obtaining a specified minimum distance between each set of coupling pairs of qubits of the quantum processor needed to satisfy a crosstalk specification of the given algorithm, the coupling pairs of qubits being defined by the coupling map; determining a set of layers defining coupling pairs of qubits for implementing the given algorithm on the quantum processor, wherein each layer corresponds to a step in time; and generating a compressed set of layers of qubit pairs based on the determined set of layers that conforms to the specified minimum distance between each set of coupling pairs of qubits and that reduces an execution time of the given algorithm in comparison to the determined set of layers.

In one aspect, a computer program product comprises one or more tangible computer-readable storage media and program instructions stored on at least one of the one or more tangible computer-readable storage media, the program instructions executable by a processor, the program instructions comprising obtaining a given algorithm to be implemented on a quantum processor; obtaining a coupling map for the quantum processor; obtaining a specified minimum distance between each set of coupling pairs of qubits of the quantum processor needed to satisfy a crosstalk specification of the given algorithm, the coupling pairs of qubits being defined by the coupling map; determining a set of layers defining coupling pairs of qubits for implementing the given algorithm on the quantum processor, wherein each layer corresponds to a step in time; and generating a compressed set of layers of qubit pairs based on the determined set of layers that conforms to the specified minimum distance between each set of coupling pairs of qubits and that reduces an execution time of the given algorithm in comparison to the determined set of layers.

In one aspect, an apparatus comprises a memory and at least one processor, coupled to the memory, and operative to perform operations comprising obtaining a given algorithm to be implemented on a quantum processor; obtaining a coupling map for the quantum processor; obtaining a specified minimum distance between each set of coupling pairs of qubits of the quantum processor needed to satisfy a crosstalk specification of the given algorithm, the coupling pairs of qubits being defined by the coupling map; determining a set of layers defining coupling pairs of qubits for implementing the given algorithm on the quantum processor, wherein each layer corresponds to a step in time; and generating a compressed set of layers of qubit pairs based on the determined set of layers that conforms to the specified minimum distance between each set of coupling pairs of qubits and that reduces an execution time of the given algorithm in comparison to the determined set of layers.

In one example embodiment, the determining of the set of layers further comprises determining a size of an adjacency matrix, the size being equal to a square of a length of an initial layout based on the specified minimum distance (operation 604); converting the coupling map to a coupling map dictionary (coupling_map_dict), where each key of the coupling map dictionary is a first qubit of a given qubit pair and a value of the coupling map dictionary is a second qubit of the given qubit pair (operation 612); given a sorted initial layout (sorted_init_layout), obtaining an index within the sorted initial layout and a value of each qubit in the sorted initial layout; populating an initial layout lookup dictionary (initial_layout_lookup), where a key of the initial layout lookup dictionary corresponds to a qubit and a value of the initial layout lookup dictionary corresponds to the index; and deriving the adjacency matrix from the coupling map by initializing the adjacency matrix with zero values and, for every connection between first and second qubits of a coupling pair, setting a corresponding entry of the adjacency matrix with a value of one (operation 624).

In one example embodiment, the determining the set of layers further comprises performing matrix multiplication on the adjacency matrix while maintaining one or more intermediate matrices for checking if a given coupling pair is spaced at least the specified minimum distance apart (operation 704); obtaining a final matrix for use with the intermediate matrices (operation 708); and accessing the final matrix and extracting qubit identifiers from the sorted initial layout (sorted_init_layout) when a value of the final matrix is equal to one and formatting data with a key equal to a start qubit and a value(list) equal to the second qubit (operation 712).

In one example embodiment, the determining the set of layers further comprises resetting a tally of sets having a minimum number of layers, resetting a tally of used pairs of qubits used within any of layer and initializing a list of available pairs of qubits identified in a reduced coupling map for placement of available qubits into a layer of a given set of layers (operation 804); determining a set of layers for each start qubit (operation 808, see FIG. 9); determining a set of unique layers of pairs (operation 812); and determining at least one set of minimum layer unique layers of pairs (operation 816).

In one example embodiment, the determining the set of layers for each start qubit further comprises iterating through each qubit of the reduced coupling map and through qubits connected to the qubit being iterated through (operation 904), the iterating further comprising performing recursive logic to generate a layer of qubit pairs (grouping_pair) where the qubit pairs are the specified minimum distance apart (operation 908; FIG. 10); for each layer, adding to a tally of used pairs of qubits (operation 912); resetting a tally of used qubits (operation 916); and updating the reduced coupling map by removing qubit pairs that are in the tally of used pairs of qubits (operation 920).

In one example embodiment, the performing recursive logic further comprises searching for a pair of qubits that is at least the specified minimum distance from the qubit pair being considered (operation 1004); accessing an entangling dictionary that comprises a key corresponding to each qubit being considered and a value that is a list of qubits which are at least the specified minimum distance away from the qubit corresponding to the key to obtain the list of qubits which are at least the specified minimum distance away from the qubit being considered (operation 1008); performing a check to determine if an unassigned pair of qubits are at least the specified minimum distance apart from all pairs of qubits within the layer of qubit pairs; and adding the unassigned pair of qubits to the tally of used qubits and to the layer of qubit pairs if the unassigned pair of qubits are at least the specified minimum distance apart from all pairs of qubits within the layer of qubit pairs (operation 1012).

In one example embodiment, the generating the compressed set of layers of qubit pairs further comprises repeating for each given set of layers within the set of unique_layers of pairs: sorting each given set of layers from a greatest number of pairs to a least number of pairs (defined as temp_sorted_by_len; operation 1108); using a first set of compress logic if the specified minimum distance is set to zero and using a second set of compress logic if the specified minimum distance is set to greater than zero (operation 1112); maintaining unique solution sets generated by the first set of compress logic or the second set of compress logic (operation 1116); denoting sets of the maintained unique solution sets that have a least number of layers (operation 1120); and generating a set of minimum combined layers having the least number of layers by maintaining sets of layers having the least number of layers and discarding sets having more than the least number of layers (operation 1124).

In one example embodiment, the quantum processor is physically instantiated based on the compressed set of layers of qubit pairs.

In one example embodiment, properties of the given algorithm executing on the quantum processor are simulated based on the compressed set of layers of qubit pairs. In one example embodiment, the given algorithm is revised and re-simulated in response to detecting a failure with the given algorithm during the initial simulation.

In one example embodiment, the coupling map describes a connectivity of qubits, an initial layout comprises identifiers of qubits within the coupling map which are selected for execution, a layer is a set of pairs of coupled qubits, where all the qubit pairs from the initial layout are divided into layers such that the pairs of coupled qubits are at least the specified minimum distance apart, and a reduced coupling map is a dictionary having a key corresponding to a given qubit and a value that is a list of qubits that are be a potential pair partner for the given qubit.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a quantum processor computer-aided design tool 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining a given algorithm to be implemented on a quantum processor;
obtaining a coupling map for the quantum processor;
obtaining a specified minimum distance between each set of coupling pairs of qubits of the quantum processor needed to satisfy a crosstalk specification of the given algorithm, the coupling pairs of qubits being defined by the coupling map;
determining a set of layers defining coupling pairs of qubits for implementing the given algorithm on the quantum processor, wherein each layer corresponds to a step in time; and
generating a compressed set of layers of qubit pairs based on the determined set of layers that conforms to the specified minimum distance between each set of coupling pairs of qubits and that reduces an execution time of the given algorithm in comparison to the determined set of layers.

2. The computer-implemented method of claim 1, wherein the determining of the set of layers further comprises:
determining a size of an adjacency matrix, the size being equal to a square of a length of an initial layout based on the specified minimum distance;
converting the coupling map to a coupling map dictionary, where each key of the coupling map dictionary is a first qubit of a given qubit pair and a value of the coupling map dictionary is a second qubit of the given qubit pair;
given a sorted initial layout, obtaining an index within the sorted initial layout and a value of each qubit in the sorted initial layout;
populating an initial layout lookup dictionary, where a key of the initial layout lookup dictionary corresponds to a qubit and a value of the initial layout lookup dictionary corresponds to the index; and
deriving the adjacency matrix from the coupling map by initializing the adjacency matrix with zero values and, for every connection between first and second qubits of a coupling pair, setting a corresponding entry of the adjacency matrix with a value of one.

3. The computer-implemented method of claim 2, wherein the determining the set of layers further comprises:
performing matrix multiplication on the adjacency matrix while maintaining one or more intermediate matrices for checking if a given coupling pair is spaced at least the specified minimum distance apart;
obtaining a final matrix for use with the intermediate matrices; and
accessing the final matrix and extracting qubit identifiers from the sorted initial layout when a value of the final matrix is equal to one and formatting data with a key equal to a start qubit and a value(list) equal to the second qubit.

4. The computer-implemented method of claim 3, wherein the determining the set of layers further comprises:
resetting a tally of sets having a minimum number of layers, resetting a tally of used pairs of qubits used within any of layer and initializing a list of available pairs of qubits identified in a reduced coupling map for placement of available qubits into a layer of a given set of layers;
determining a set of layers for each start qubit;
determining a set of unique layers of pairs; and
determining at least one set of minimum layer unique layers of pairs.

5. The computer-implemented method of claim 4, wherein the determining the set of layers for each start qubit further comprises:
iterating through each qubit of the reduced coupling map and through qubits connected to the qubit being iterated through, the iterating further comprising performing recursive logic to generate a layer of qubit pairs where the qubit pairs are the specified minimum distance apart; for each layer, adding to a tally of used pairs of qubits; resetting a tally of used qubits; and updating the reduced coupling map by removing qubit pairs that are in the tally of used pairs of qubits.

6. The computer-implemented method of claim 5, wherein the performing recursive logic further comprises:
searching for a pair of qubits that is at least the specified minimum distance from the qubit pair being considered;
accessing an entangling dictionary that comprises a key corresponding to each qubit being considered and a value that is a list of qubits which are at least the specified minimum distance away from the qubit corresponding to the key to obtain the list of qubits which are at least the specified minimum distance away from the qubit being considered;
performing a check to determine if an unassigned pair of qubits are at least the specified minimum distance apart from all pairs of qubits within the layer of qubit pairs; and
adding the unassigned pair of qubits to the tally of used qubits and to the layer of qubit pairs if the unassigned pair of qubits are at least the specified minimum distance apart from all pairs of qubits within the layer of qubit pairs.

7. The computer-implemented method of claim 4, wherein the generating the compressed set of layers of qubit pairs further comprises:
repeating for each given set of layers within the set of unique layers of pairs:
sorting each given set of layers from a greatest number of pairs to a least number of pairs;
using a first set of compress logic if the specified minimum distance is set to zero and using a second set of compress logic if the specified minimum distance is set to greater than zero;
maintaining unique solution sets generated by the first set of compress logic or the second set of compress logic;
denoting sets of the maintained unique solution sets that have a least number of layers; and
generating a set of minimum combined layers having the least number of layers by maintaining sets of layers having the least number of layers and discarding sets having more than the least number of layers.

8. The method of claim 1, further comprising physically instantiating the quantum processor based on the compressed set of layers of qubit pairs.

9. The method of claim 1, further comprising simulating properties of executing the given algorithm on the quantum processor based on the compressed set of layers of qubit pairs.

10. A computer program product, comprising:
one or more tangible computer-readable storage media and program instructions stored on at least one of the one or more tangible computer-readable storage media, the program instructions executable by a processor, the program instructions comprising:
obtaining a given algorithm to be implemented on a quantum processor;
obtaining a coupling map for the quantum processor;
obtaining a specified minimum distance between each set of coupling pairs of qubits of the quantum processor needed to satisfy a crosstalk specification of the given algorithm, the coupling pairs of qubits being defined by the coupling map;
determining a set of layers defining coupling pairs of qubits for implementing the given algorithm on the quantum processor, wherein each layer corresponds to a step in time; and
generating a compressed set of layers of qubit pairs based on the determined set of layers that conforms to the specified minimum distance between each set of coupling pairs of qubits and that reduces an execution time of the given algorithm in comparison to the determined set of layers.

11. The computer program product of claim 10, wherein the determining of the set of layers further comprises:
determining a size of an adjacency matrix, the size being equal to a square of a length of an initial layout based on the specified minimum distance;
converting the coupling map to a coupling map dictionary, where each key of the coupling map dictionary is a first qubit of a given qubit pair and a value of the coupling map dictionary is a second qubit of the given qubit pair;
given a sorted initial layout, obtaining an index within the sorted initial layout and a value of each qubit in the sorted initial layout;
populating an initial layout lookup dictionary, where a key of the initial layout lookup dictionary corresponds to a qubit and a value of the initial layout lookup dictionary corresponds to the index; and
deriving the adjacency matrix from the coupling map by initializing the adjacency matrix with zero values and, for every connection between first and second qubits of a coupling pair, setting a corresponding entry of the adjacency matrix with a value of one.

12. A system comprising:
a memory; and
at least one processor, coupled to said memory, and operative to perform operations comprising:
obtaining a given algorithm to be implemented on a quantum processor;
obtaining a coupling map for the quantum processor;
obtaining a specified minimum distance between each set of coupling pairs of qubits of the quantum processor needed to satisfy a crosstalk specification of the given algorithm, the coupling pairs of qubits being defined by the coupling map;
determining a set of layers defining coupling pairs of qubits for implementing the given algorithm on the quantum processor, wherein each layer corresponds to a step in time; and generating a compressed set of layers of qubit pairs based on the determined set of layers that conforms to the specified minimum distance between each set of coupling pairs of qubits and that reduces an execution time of the given algorithm in comparison to the determined set of layers.

13. The system of claim 12, wherein the determining of the set of layers further comprises:
determining a size of an adjacency matrix, the size being equal to a square of a length of an initial layout based on the specified minimum distance;
converting the coupling map to a coupling map dictionary, where each key of the coupling map dictionary is a first qubit of a given qubit pair and a value of the coupling map dictionary is a second qubit of the given qubit pair;
given a sorted initial layout, obtaining an index within the sorted initial layout and a value of each qubit in the sorted initial layout;
populating an initial layout lookup dictionary, where a key of the initial layout lookup dictionary corresponds to a qubit and a value of the initial layout lookup dictionary corresponds to the index; and
deriving the adjacency matrix from the coupling map by initializing the adjacency matrix with zero values and, for every connection between first and second qubits of a coupling pair, setting a corresponding entry of the adjacency matrix with a value of one.

14. The system of claim 13, wherein the determining the set of layers further comprises:
performing matrix multiplication on the adjacency matrix while maintaining one or more intermediate matrices for checking if a given coupling pair is spaced at least the specified minimum distance apart;
obtaining a final matrix for use with the intermediate matrices; and
accessing the final matrix and extracting qubit identifiers from the sorted initial layout when a value of the final matrix is equal to one and formatting data with a key equal to a start qubit and a value(list) equal to the second qubit.

15. The system of claim 14, wherein the determining the set of layers further comprises:
resetting a tally of sets having a minimum number of layers, resetting a tally of used pairs of qubits used within any of layer and initializing a list of available pairs of qubits identified in a reduced coupling map for placement of available qubits into a layer of a given set of layers;
determining a set of layers for each start qubit;
determining a set of unique layers of pairs; and
determining at least one set of minimum layer unique layers of pairs.

16. The system of claim 15, wherein the determining the set of layers for each start qubit further comprises:
iterating through each qubit of the reduced coupling map and through qubits connected to the qubit being iterated through, the iterating further comprising performing recursive logic to generate a layer of qubit pairs where the qubit pairs are the specified minimum distance apart;
for each layer, adding to a tally of used pairs of qubits; resetting a tally of used qubits; and
updating the reduced coupling map by removing qubit pairs that are in the tally of used pairs of qubits.

17. The system of claim 16, wherein the performing recursive logic further comprises:
searching for a pair of qubits that is at least the specified minimum distance from the qubit pair being considered;
accessing an entangling dictionary that comprises a key corresponding to each qubit being considered and a value that is a list of qubits which are at least the specified minimum distance away from the qubit corresponding to the key to obtain the list of qubits which are at least the specified minimum distance away from the qubit being considered;
performing a check to determine if an unassigned pair of qubits are at least the specified minimum distance apart from all pairs of qubits within the layer of qubit pairs; and
adding the unassigned pair of qubits to the tally of used qubits and to the layer of qubit pairs if the unassigned pair of qubits are at least the specified minimum distance apart from all pairs of qubits within the layer of qubit pairs.

18. The system of claim 15, wherein the generating the compressed set of layers of qubit pairs further comprises:
repeating for each given set of layers within the set of unique layers of pairs:
sorting each given set of layers from a greatest number of pairs to a least number of pairs;
using a first set of compress logic if the specified minimum distance is set to zero and using a second set of compress logic if the specified minimum distance is set to greater than zero;
maintaining unique solution sets generated by the first set of compress logic or the second set of compress logic;
denoting sets of the maintained unique solution sets that have a least number of layers; and
generating a set of minimum combined layers having the least number of layers by maintaining sets of layers having the least number of layers and discarding sets having more than the least number of layers.

19. The system of claim 12, the operations further comprising physically instantiating the quantum processor based on the compressed set of layers of qubit pairs.

20. The system of claim 12, the operations further comprising simulating properties of executing the given algorithm on the quantum processor based on the compressed set of layers of qubit pairs.
